(19) United States
(12) Patent Application Publication
(10) Pub. No.: US 2017/0142457 A1
(43) Pub. Date: May 18, 2017

(54) SYSTEMS AND METHODS FOR OBSFUSCATING REGIONAL REFERENCES IN A COD ENVIRONMENT

(71) Applicant: Canoe Ventures, LLC, Englewood, CO (US)

(72) Inventors: Timothy R. Whitton, Englewood, CO (US); Jason Canney, Highlands Ranch, CO (US)

(21) Appl. No.: 14/943,741

(22) Filed: Nov. 17, 2015

(51) Int. Cl. H04N 21/234; H04N 21/262; H04N 21/235; H04N 21/81; H04N 21/258

(52) U.S. Cl. CPC H04N 21/23424; H04N 21/812; H04N 21/25841; H04N 21/2351; H04N 21/26208

(57) ABSTRACT

One system herein is operable in a COD environment and includes a request manager. The request manager is operable to process a request from an asset decision system for assets available for insertion into a COD content selection, and to determine a geographic region of the COD content selection, and to determine availability of assets in the geographic region, to format a message with the available assets in the geographic region. The geographic region is one of a plurality of geographic regions in a COD delivery footprint of the COD content selection. The request manager is also operable to obfuscate the geographic region in the message, and to transfer the message to the asset decision system for a determination of assets for insertion into the COD content selection.

### CROSS REFERENCE TO RELATED APPLICATIONS

This patent application is related to commonly owned and co-pending patent applications 13/628,324, 13/628,360, and 13/628,381 (each having a filing date of Sep. 27, 2012), the entire contents of each of which are incorporated by reference.

### FIELD OF THE INVENTION

The invention relates to the field of Content On Demand (COD) systems and asset insertions into COD content selections.

### BACKGROUND

Television networks, such as the American Broadcasting Company (ABC), the Columbia Broadcasting Company (CBS), and the National Broadcasting Company (NBC), have for years broadcast television shows to the masses as a means for generating revenue through advertising. For example, these networks produce television shows and then seek out sponsors to advertise on the shows. The television shows, or “content”, have designated timeslots in which the sponsors' advertisements, or “assets”, are inserted. The content and the inserted assets are then broadcast by the television networks, or “content owners”, to the public over federally licensed communication airways, occasionally referred to as linear video distribution.

This “shotgun” approach to advertising proved to be very successful in the beginning However, as the number of advertisers wishing to sell their goods and services increased, television evolved into a much more complex system of communications. Today, cable television providers and satellite television providers (e.g., “content providers”) serve as intermediary content providers between the content owners and the intended public audience. And, the number of content owners has increased accordingly. In this regard, many members of the general public have signed on as customers of the cable/satellite content providers so as to receive a broader availability of content.

Because the market for content consumption has grown, the number of content providers has also grown. And, because each of these providers has its own method of content delivery, the manner in which the content and assets are delivered to the customers has become increasingly complex. Generally, the content owners deliver the content to the content providers with instructions to insert various national assets into the content at certain times. For example, if a company wishes to run a national advertisement campaign targeting a certain television show associated with a particular demographic, the company may purchase one or more timeslots, or “placement opportunities”, within that television show from the content owner to air assets advertising the goods and services of the company. The content owner then provides the content to each of the content providers with directions to insert the assets within the timeslots purchased by the company.

The content providers may also have certain timeslots available for inserting certain local assets. For example, a content provider may have “headends” configured in various communities to distribute content to their customers located therein. Each headend receives content from the content providers with various designated timeslots for inserting assets into the content. Some of those timeslots may be designated for local advertisements where companies within the service area of the headend wish to advertise. These companies purchase those timeslots from the content provider for insertion of their assets to expose the customers to their advertising at the more local level.

As complex as the cable/satellite television has become, certain devices have come along to change and/or circumvent these forms of marketing altogether. The digital recorder, such as that produced by Tivo, is one example of a means for avoiding the asset insertions of marketing strategists. With the digital recorder, the content providers' customers are able to digitally record entire episodes of content and view that content at their leisure, as opposed to a time established by the content providers. However, these customers can also use the digital recorders to fast-forward or skip through the assets without viewing them, much to the dismay of the asset owners.

In response, content providers started providing content on a “Content On Demand” (COD) basis, sometimes referred to as nonlinear video distribution. In COD, the content provider delivers the content to the content provider which in turn maintains the content for subsequent and individual distribution to their customers. Thus, a customer may select a desired content through a set-top box (STB), a smart phone, computer, or the like (collectively referred to herein as “customer premise equipment” or “CPE”) and watch that content at the customer's leisure.

This COD content can also be configured with timeslots where assets may be inserted. For example, an advertiser desiring to place an advertisement in a particular TV show may pay the owner of that TV show (e.g., a content provider such as NBC, ABC, CBS, etc.) to insert their advertisements into one or more the timeslots in the COD content. Once inserted, the asset is delivered in the COD content to a user's CPE.

Generally, the COD content providers are geographically diverse. For example, the content provider Comcast Cable operates in the Denver, Colorado market, whereas the content provider Cox Cable operates in the Phoenix, Arizona market. So, when a content provider delivers a COD content to one of its subscribers, that delivery is in a specific geographic footprint.

Assets may be inserted into COD content selections in any of these geographic footprints. However, the assets themselves may be available for insertion in regions that are smaller than the geographic footprints of the COD content selections. These regions are generally referred to as asset availability regions. And, when a COD provider is tasked to insert assets into the COD content selections, they may be directed to contact a third party asset decision system (ADS) for asset insertion decisions. For example, the COD provider may be operable to insert assets into COD content selections. But, the COD provider may not have any means available to determine which assets will be the most effective, profitable, etc. Thus, the owner of the COD content may direct the COD provider to contact one of its preferred ADSs to make such decisions.

The ADSs generally do not have access to information pertaining to the asset availability regions and the assets available therein. This is so the COD providers can prevent COD content owners from bypassing the COD providers and directly targeting assets to subscribers of the COD providers. However, when the COD provider is forced to use the ADS of the COD content owners, they may unknowingly make the asset availability region information public and thus make the information known to the COD content owners.

Summary

Systems and methods presented herein provide for obfuscating geographic identifiers of COD content selections. One system herein is operable in a COD environment and includes a request manager. The request manager is operable to process a request from an ADS for assets available for insertion into a COD content selection, to determine a geographic region of the COD content selection, to determine availability of assets in the geographic region, and to format a message with the available assets in the geographic region. The geographic region is one of a plurality of geographic regions in a COD delivery footprint of the COD content selection. The request manager is also operable to obfuscate the geographic region in the message, and to transfer the message to the asset decision system for a determination of assets for insertion into the COD content selection.

The various embodiments disclosed herein may be implemented in a variety of ways as a matter of design choice. For example, the embodiments may take the form of physical machines, computer hardware, software, firmware, or combinations thereof. In one embodiment, a computer readable medium is operable to store software instructions for directing the asset insertion into content. These software instructions are configured so as to direct a processor or some other processing system to operate in the manner described above. Other exemplary embodiments are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary COD insertion request manager operable in a COD environment comprising a plurality of ADSs and content owners.

FIG. 2 is a block diagram of the COD insertion request manager illustrating an exemplary operation with the exemplary ADS and a COD provider for an asset availability region.

FIG. 3 is a flowchart of an exemplary process operable of the COD insertion request manager.

FIG. 4 is a more detailed block diagram of the COD insertion request manager operating with an exemplary ADS.

FIG. 5 is a block diagram of a headend operable with an exemplary ADS.

FIG. 6 is an exemplary timing diagram of a COD content selection with timeslots available for asset insertion.

FIG. 7 is a block diagram of an exemplary ADS.

FIG. 8 is a block diagram of an exemplary cable television network.

FIG. 9 is a block diagram of an exemplary processing system operable to implement at least portions of the embodiment herein.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

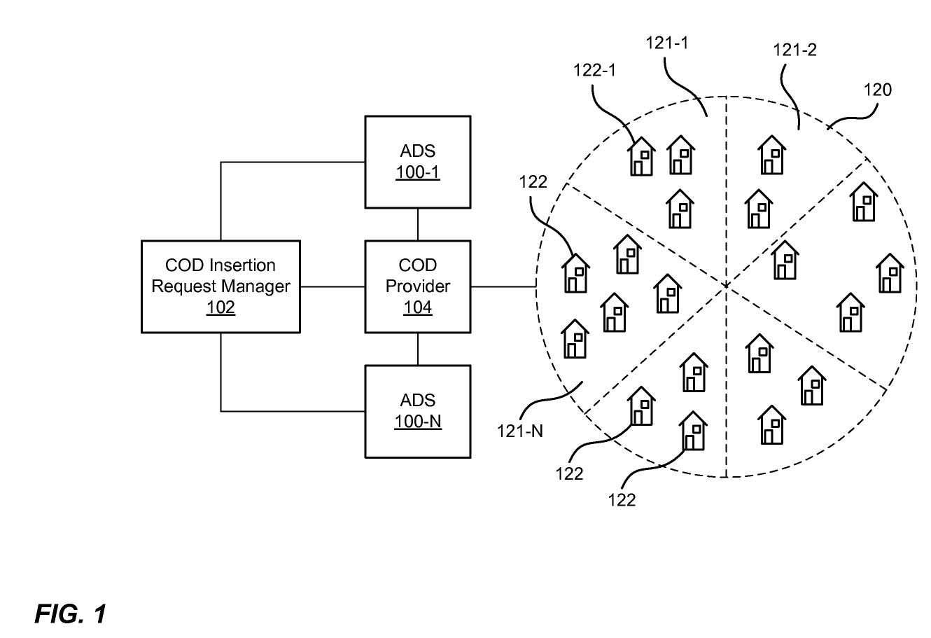

FIG. 1 is a block diagram of an exemplary COD insertion request manager 102 operable in a COD environment comprising a plurality of ADSs 100-1-100-N (where the reference number “N” indicates an integer greater than “1” and not necessarily equal to any other “N” reference designated herein). The COD insertion request manager 102 is operable to provide asset information to the ADSs 100 and the COD content provider 104 such that the COD provider 104 can insert assets into COD content being delivered to subscribers 122 in the COD content delivery footprint 120.

As mentioned, the COD provider 104 may deliver COD content within the COD content delivery footprint 120. Thus, whenever a subscriber 122 makes a selection of a particular COD content that is available within the footprint 120, the COD provider 104 can deliver that COD content to the subscriber through the subscriber's CPE. Generally, COD content that is available within the footprint 120 is available to any of the subscribers 122 within the footprint 120. However, the footprint 120 can also include Internet streaming video access which the subscribers 122 may access with their mobile devices (e.g., away from their residences and physically outside the footprint 120).

Also mentioned, assets that may be inserted into a COD content selection are not necessarily available throughout the entire COD content delivery footprint 120. For example, an advertisement for Kleenex tissue may be available in the asset availability regions 121-1 and 121-2 but unavailable in the remaining asset availability regions 121-3-121-N in the COD content delivery footprint 120.

When the subscriber 122 selects COD content available in the COD content delivery footprint 120 (e.g., through the subscribers CPE), the COD provider 104 retrieves that COD content and delivers that content to the subscriber 122. Before delivering that COD content, the COD provider 104 contacts one or more the ADSs 100-1-100-N for a determination of which assets should be inserted into the subscriber COD content selection.

The ADSs 100 are generally separate entities that do not possess the actual assets. Rather, the ADSs 100 process information about assets to determine appropriate selection and ranking of the assets for insertion into the COD content being provided by the COD provider 104. For example, the content provided by the COD provider 104 is typically owned by another entity, a “content owner”. To generate revenue from the content, the content owner inserts advertisements into the content before delivery to a user. In COD content delivery, the COD provider 104 (e.g., a cable company, a satellite television provider, the streaming video provider, etc.) provides the COD content on behalf of the content owner. This leaves the COD provider 104 in control of inserting the assets into the COD content of the content owner.

To ensure that assets desired by the content owners are inserted into the COD content being provided by the COD provider 104 and to increase revenues, the content owners direct the COD provider 104 to employ the services of the ADSs 100. And, as the ADSs 100 do not possess the actual assets or even have knowledge of the assets available in the asset availability regions 121, the ADSs 100 contact the COD insertion request manager 102 for a list of available assets.

Depending on the asset insertion decisioning performed by a particular ADS 100, a content owner could determine over time the availability of assets in a particular asset availability region 121. For example, by monitoring the asset insertion decisions by the ADS 100-1 in the COD content delivery footprint 120, a content owner may identify individual asset availability regions 121 and then deduce the availability of certain assets in the asset availability regions 121. The content owner could then begin to directly target the subscribers 122 based on the identified asset availability regions 121.

Alternatively or additionally, depending on where a subscriber 122 is requesting content, the COD provider 104 may contact the ADS 100 closest to that subscriber 122 to perform the asset insertion decisioning. This could also assist the content owner in deducing the availability of assets in a region 121. For example, assume that the subscriber 122-1 has selected COD content for delivery from the COD provider 104 and that the ADS 100-1 is closest to the subscriber 122-1. The COD provider 104 would then contact the ADS 100-1 to perform the asset insertion decisioning for that COD content selection. Knowing the identification and location of the ADS-100, the content owner could deduce the geographic location of the subscriber 122-1 and directly target the subscribers 122-1.

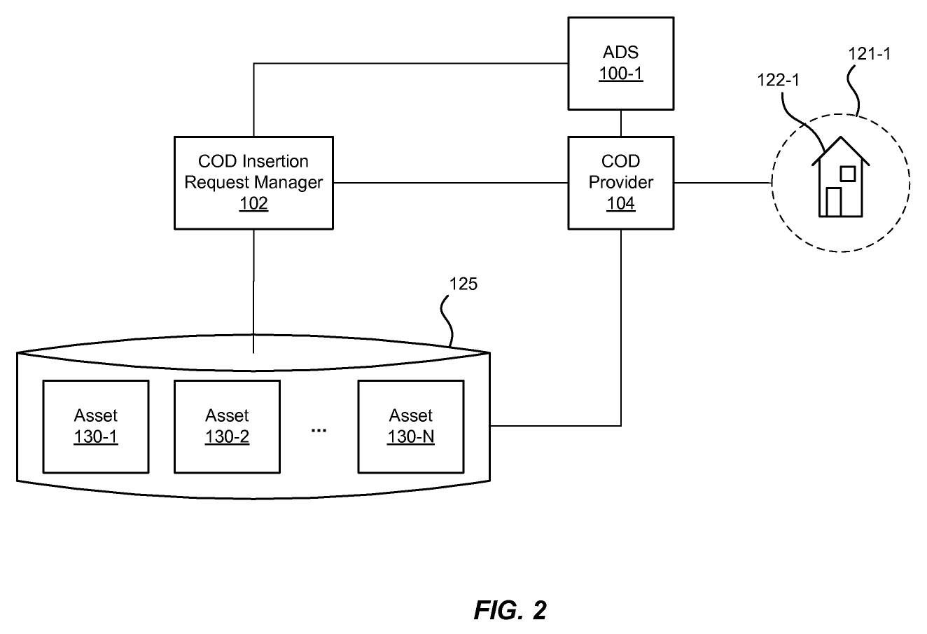

The COD insertion request manager 102 counters the ability of the content owner to deduce the availability of assets and/or their corresponding asset availability regions 121 by obfuscating geographic identifiers during the asset decisioning process. One exemplary operation of the COD insertion request manager 102 is now shown and described in the block diagram of FIG. 2.

In FIG. 2 the COD insertion request manager 102 works in conjunction with the ADS 100-1 and the COD provider 104 for delivering assets in a COD content selection made in an asset availability region 121-1. In this example, assume that the subscriber 122-1 selects an episode of “Mad Men” for on-demand delivery by the COD provider 104. The COD provider 104, not desiring to reveal the geographic location of the subscriber 122-1, contacts the ADS 100-1 for a list of assets to be inserted into that Mad Men episode. The ADS 100-1, not having access to or knowledge of the assets that are available in the asset availability region 121-1, contacts the COD insertion request manager 102 for a list of available assets.

The COD insertion request manager 102 retrieves the geographic location of the subscriber 122-1 from the COD provider 104 to determine which assets are available in the asset availability region 121-1. In doing so, the COD insertion request manager 102 may contact a national database 125 of assets 130-1-130-N that maintains the availability of the assets 130 throughout multiple COD content delivery footprints 120.

The COD insertion request manager 102 delivers a list of available assets in that region 121-1 without revealing the geographic location of that region and/or the subscriber 122-1. More specifically, the COD insertion request manager 102 obfuscates the geographic identifiers associated with the available assets.

The ADS 100-1, in turn, processes the list of available assets without knowledge of the region 121-1 or even knowledge of the COD content delivery footprint 120 to deliver a ranked listing of assets to the COD provider 104 for insertion into the COD content selection made by the subscriber 122-1. Once that list of ranked assets is received, the COD provider 104 retrieves the assets from the national database 125 of assets. The COD provider 104 then inserts those assets into the COD content selection of the subscriber 122-1 and delivers the COD content selection to that subscriber.

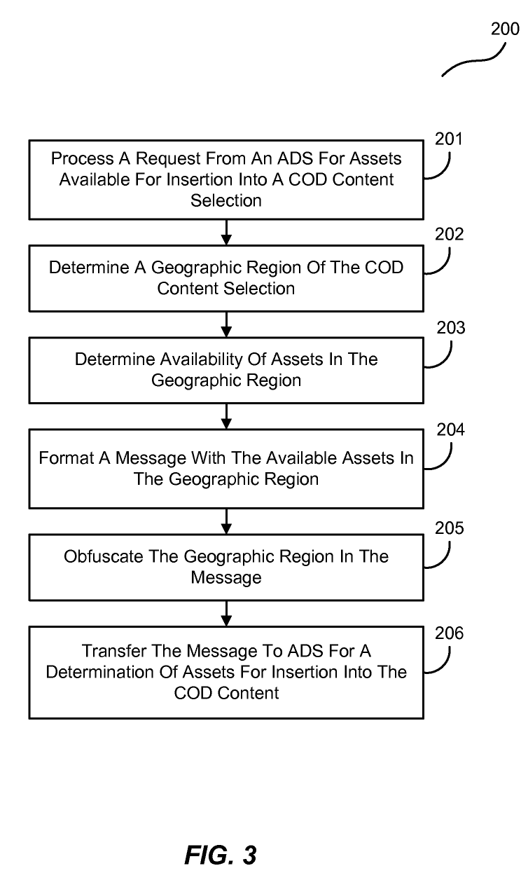

FIG. 3 is a flowchart of a process 200 operable with the COD insertion request manager 102 in one exemplary embodiment. The process 200 initiates when a subscriber 122 requests COD content from the COD provider 104. At that point, the COD provider 104 initiates asset insertion processing that will provide assets within the subscriber's COD content selection. In doing so, the COD provider 104 contacts an ADS 100 for a list of assets to be inserted in the COD content selection. First, however, the ADS 100 needs to determine what assets are available for insertion into the subscriber COD content selection. The ADS 100 does so by transferring a request for available assets to the COD insertion request manager 102.

The COD insertion request manager 102 processes the request from the ADS 100, in the process element 201. Upon receiving this request, the COD insertion request manager 102 determines a geographic region of the COD content selection, in the process element 202. In doing so, the COD insertion request manager 102 may contact COD provider to ascertain the location of the subscriber 122. After determining the subscriber's geographic location, the COD insertion request manager 102 determines the availability of assets in that geographic region, in the process element 203.

Once the list of available assets has been determined, the COD insertion request manager 102 formats a message with those assets, in the process element 204. To prevent the ADS 100 from obtaining the geographic information, the COD insertion request manager 102 obfuscates the geographic region of the subscriber 122 within the message to the ADS 100, in the process element 205. With the geographic region associated with the assets and the subscriber 102 being obfuscated, the COD insertion request manager 102 transfers the message to the ADS for a determination of assets that are to be inserted in the subscriber COD content selection, in the process element 206.

Once the ADS 100 performs the asset decisioning from the list of available assets, the ADS 100 transfers a ranked list of assets for insertion into the subscriber COD content. The asset decisioning of the ADS 100 may be performed in a variety of ways as a matter of design choice. Exemplary embodiments of the ADS 100 are shown and described in greater detail below.

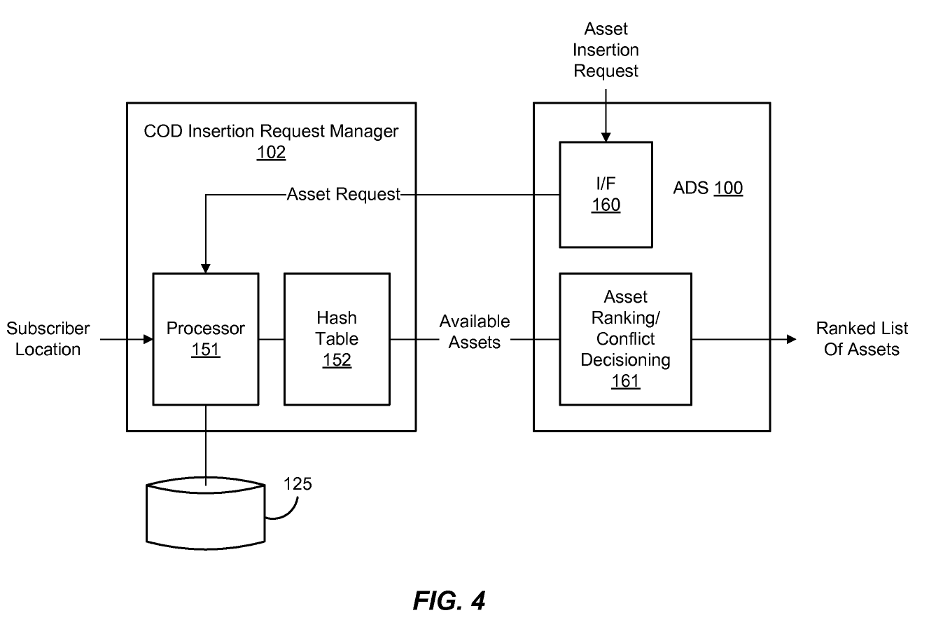

FIG. 4 is a more detailed block diagram of the COD insertion request manager 102 operating with an exemplary ADS 100. In this embodiment, the ADS 100 comprises an interface 160 that receives and processes a COD asset insertion request from the COD provider 104 when a subscriber 122 selects COD content. The ADS 100 determines which assets should be inserted into the COD content via the asset ranking/conflict decisioning module 161. Examples of the ADS 100 are shown and described in greater detail below.

The ADS 100 does not have the assets available at its disposal. Accordingly, the ADS 100 requests a list of assets that are available by sending an asset request message to the COD insertion request manager 102. The COD insertion request manager 102 processes the request with a processor 151. The COD insertion request manager 102 then requests the geographic location of the subscriber 102 selecting the COD content from the COD provider 104. The processor 151 then uses the geographic location of the subscriber 102 to identify assets 130 within the national asset database 125.

The processor 151 then formats a message (e.g., a data structure) with the available assets along with their asset availability regions 121. Before transferring the message to the ADS 100, the COD insertion request manager 102, in this embodiment, obfuscates the asset availability regions 121 of the assets in the message by passing the asset availability region information through a hash table 152. The COD insertion request manager 102 then transfers the available assets and their hashing algorithm encrypted asset availability regions 121 to the asset ranking/conflict decisioning module 161 of the ADS 100. Thus, the asset identifications and any other relevant information pertaining to the assets can be ranked based on the functionality of the ADS 100 without revealing the asset availability region information pertaining to those assets.

The ranked assets with their encrypted asset availability regions 121 are then passed to the COD provider 104 such that the COD provider 104 can contact the national database 125 to retrieve the assets ranked by the ADS 100 and insert those assets into the subscribers COD content selection.

To further illustrate, assume that the asset 130-1 (FIG. 2) has availability in the COD content delivery footprint 120 (FIG. 1) as follows:
Availability Region 121-1=Available
Availability Region 121-2=Not Available
Availability Region 121-3=Not Available
Availability Region 121-4=Available
Availability Region 121-5=Available

Now assume that the subscriber 122-1 makes a COD content selection of the COD provider 104. The COD insertion request manager 102, upon receiving the request from the ADS 100, formats a message to the ADS 100 stating that the asset 130-1 is available for insertion into the COD content selection. The hash table 152 of the COD insertion request manager 102 encrypts the asset availability region information in the message simply revealing that the asset 130-1 is available as follows:

asset 130-1 @ location 254e397d31fe4b0877b6ac6248d4cd4e=Available.

The message is then forwarded to the ADS 100 such that it can rank the asset and perform asset conflict analysis with other available assets.

Over time, even the hashing algorithm of the hash table 152 can be compromised. For example, if the content owner monitors the ADS 100 rankings and determines that the message “asset 130-1 @ location 254e397d31fe4b0877b6ac6248d4cd4e=Available” is pervasive in a particular geographic region, the content owner may deduce that the asset 130-1 is part of the asset availability region 121-1. Accordingly, the COD insertion request manager 102 may routinely change the hashing algorithm of the hash table 152. For example, the message on one day may read “asset 130-1 @ location 254e397d31fe4b0877b6ac6248d4cd4e=Available”, whereas the next day the message may read as “asset 130-1 @ location 0ac4042200000040800000407b65303e=Available” even though the locations “254e397d31fe4b0877b6ac6248d4cd4e” and “0ac4042200000040800000407b65303e” are one in the same. Changing the hashing algorithm may be performed as a matter of design choice (e.g., hours, days, weeks, etc.).

Although shown and described with respect to the COD insertion request manager 102 operating with a single ADS 100 and a single content provider 104, the invention is not intended to be so limited. Rather, the COD insertion request manager 102 can and typically is operable to function with a plurality of ADSs 100 as well as a plurality of COD providers 104. And, the number of COD selections made by subscribers is typically on the order of hundreds and thousands as COD providers 104 often serve dense metropolitan areas with large numbers of subscribers.

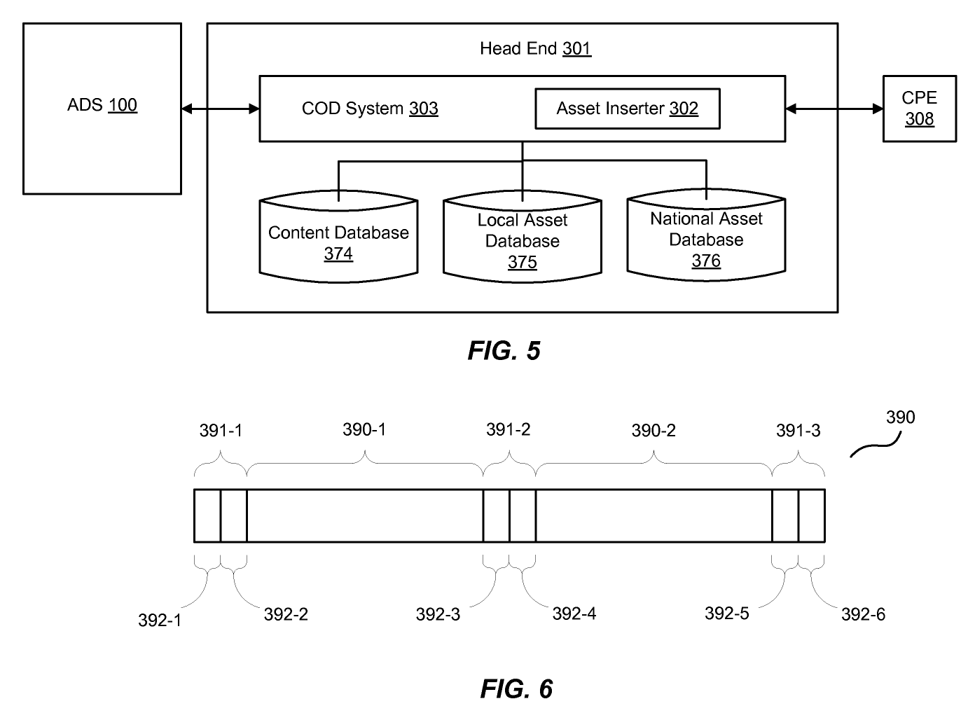

FIG. 5 is a block diagram of an exemplary ADS 100 operable with a COD system 303 (also known as a “COD back office system”) of a headend 301 (i.e., a COD provider). The ADS 100 illustrates one example of how the ADS 100 may operate. The headend 301, in this embodiment, is generally any system operable to receive content for processing and distribution to a CPE 308 (e.g., over a cable television infrastructure or from satellite). For example, the headend 301 may receive content from content providers over television signals for distribution to the customers of a cable content provider via the CPE 308.

The COD system 303 of the headend 301 provides the COD content to the CPE 308 when desired by the customer. For example, the headend 301 may receive the content from the content providers and maintain that content within a content database 374. The headend 301 may also maintain local assets in a local asset database 375 and national assets in a national asset database 376. When a particular COD content is selected by the user of the CPE 308, an asset inserter 302 of the COD system 303 accesses the content database 374 to retrieve the selected content and deliver that content to the CPE 308.

The COD system 303 is any system or device that is operable to deliver video content to the CPE 308 when directed by the CPE 308. The databases 374, 375, and 376 are any systems or devices operable to store and maintain data, audio, and/or video for subsequent distribution to the CPE 308. For example, the databases 374, 375, and 376 may be operable within a computer system that stores the video and audio (e.g., MPEG) content and assets such that they may be accessed by the COD system 303 and delivered to the CPE 308 when desired by the user of such. One or more of the databases 374, 375, and 376 may also be configured with the national database 125 described hereinabove.

The CPE 308 is any device or system capable of providing content from a content provider 104 to a user. For example, a CPE 308 may be a set-top box operable to communicate with a cable television headend. Alternatively, a CPE 308 can be a computer capable of displaying video from a network. For example, a CPE 308 may select content from an Internet website hosted with an internet server through the network. Once selected, the COD system 303 of the COD provider 104 may retrieve the content from a content database for Internet delivery (e.g., streaming video) to the selecting CPE 308. Other examples of the CPE 308 include gaming consoles, smart phones, electronic tablets, or the like.

To illustrate the insertion of assets into content, FIG. 6 shows an exemplary timing diagram of content 390 interlaced with asset timeslots 391, also known as “break positions”. When the COD system 303 receives a message from the CPE 308 for the content 390, the COD system 303 retrieves the content 390 from the content database 374. The content 390, in this embodiment, is divided into two segments 390-1 and 390-2 with timeslots 391 disposed at the front end of the content 390-1 (i.e., timeslot 391-1 at the pre roll position), in between the content segments 390-1 and 390-2 (i.e., timeslot 391-2 at the mid roll position), and at the end of the content segment 390-2 (i.e., timeslot 391-3 at the post roll position). Each timeslot 391 is divided into two asset placement timeslots 392 (i.e., asset placement opportunities), each of which is capable of accepting an asset that is typically, but not always, 30 seconds in duration. Thus, a placement opportunity is generally a subset of time of a particular timeslot 391. The ADS 100 directs the COD system 303 to insert the assets according to a particular ranking that provides value for the content provider (e.g., monetary value, enhanced relationships with asset providers, etc.). In this regard, the ADS 100 may direct the COD system 303 to select assets from the national asset database 376 and/or the local asset database 375 for insertion into the asset timeslots 392-1-392-6 based on the ranking provided by the ADS 100.

The invention is not intended be limited to any particular number of content segments 390 or any particular number of asset timeslots. In fact, an asset timeslot 392 may be subdivided for insertion of multiple assets. For example, television commercials are typically 30 seconds in length. Occasionally, however, asset providers reduce the material of certain assets to reduce the overall duration of a particular asset (e.g., by removing material from a 30 second commercial to reduce it to a 15 second commercial). Accordingly, a 30 second asset timeslot 392 may be configured to accept insertions of two 15 second assets. For example, the content 390 may be configured with the mid roll timeslot 391-2 having two 30 second asset timeslots 392-3 and 392-4. The asset timeslot 392-3 can thus be further divided into two 15 second asset timeslots 392-3-1 and 392-3-2, allowing for the insertion of two 15 second assets into the asset timeslot 392-3. Still, the invention is not intended to be limited to any particular asset duration, asset timeslot 392 duration, or timeslot 391 duration as such may be configured to meet certain business and/or technical needs.

It should be noted that the decisions regarding the direction of asset insertions occur quite rapidly. For example, the ADS 100 may be operable to make asset insertion decisions for a plurality of headends 301. And, each headend 301 may be operable to provide COD content to a plurality of CPEs 308 at any given time, possibly thousands or more. Thus, when a COD content selection is made by a particular CPE 308, the ADS 100 responds in substantially real time to ensure that the COD system 303 has ample time to retrieve and insert the assets while processing the content selected by the CPE 308.

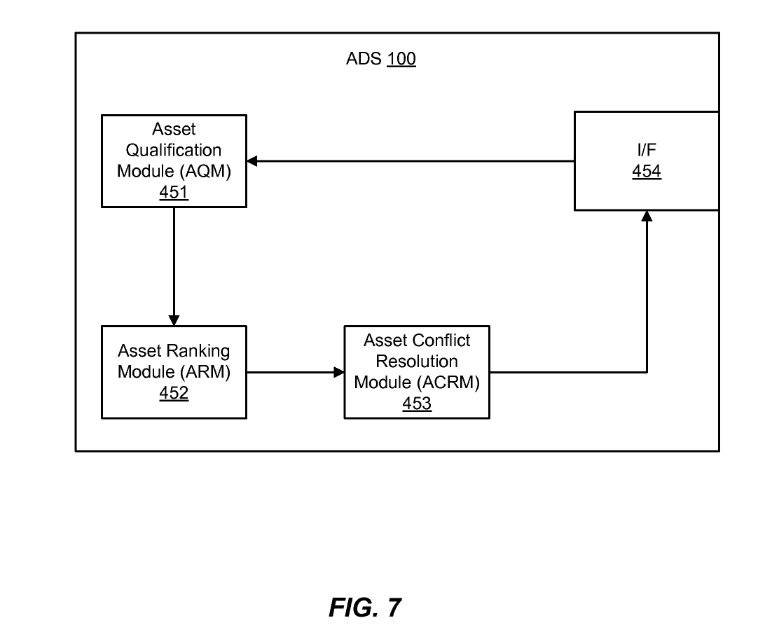

FIG. 7 is a block diagram of an exemplary ADS 100. In this embodiment, the ADS 100 includes an interface 454, an asset qualification module (AQM) 451, an asset ranking module (ARM) 452, and an asset conflict resolution module (ACRM) 453. The interface 454 is any device or system operable to receive information pertaining to a content selection by a CPE 308 such that the ADS 100 may direct asset insertion into the selected content. In this regard, the interface 454 may also be operable to transfer information to the COD system 303 to direct the COD system 303 to insert certain assets from the national asset database 376 and/or the local asset database 375.

The AQM 451 is any device or system operable to communicate with the interface 454 to initially qualify assets for insertion within the content. The AQM 451 may exclude certain assets from insertion into the content selected by the CPE 308. The ARM 452 is any device or system operable to rank the remaining assets (i.e., those not already excluded by the AQM 451) for insertion to the content 390. The ACRM 453 is any device or system operable to remove any ranked assets from insertion into the content 390 based on conflicts between assets. For example, the ACRM 453 may determine that assets from certain advertisers conflict with one another (e.g., Coke and Pepsi). Accordingly, the ACRM 453 may be operable to prevent assets from these advertisers from being inserted within a same timeslot 391 or even within a same content 390. The exemplary operations of the AQM 451, the ARM 452, and the ACRM 453 are explained in greater detail below.

Overall, the ADS 100 is any system, device, software, or combination thereof operable to process information about assets (e.g., advertisements, marketing materials, etc.) of asset providers (e.g., asset owners 101) such that the ADS 100 can direct a content provider to insert assets from the asset providers into COD content selected by a CPE 308. The ADS 100, being communicatively coupled to the COD system 303, processes information pertaining to the content selection and selects assets for insertion into that content from a national asset database and/or a local asset database, as illustrated in FIG. 5. To provide more context to the operations of the ADS 100, the following example is provided.

To illustrate, a CPE 308 selects a particular episode of the television show “30 Rock” at 8pm on a Thursday night from a menu of COD content that is presented by the COD system 303. The COD system 303 retrieves that episode of 30 Rock from the content database 374. The COD system 303 then retrieves certain assets from the national asset database 376 for insertion into the timeslots of that show. As with many other 30 minute situational comedies, this episode of 30 Rock includes two content sections 390-1 and 390-2 and the three timeslots 391-1, 391-2, and 391-3, as illustrated in FIG. 3. Using this example, the COD system 303 transfers an asset insertion request to the AQM 451 to insert assets into these three timeslots. The AQM 451 then determines that there are a total of six 30 second asset placement opportunities within three timeslots 391-1-3 of the selected content 390. The AQM 451 then processes the active campaigns to determine their eligibility within those six 30 second asset placement opportunities. Among the active campaigns in this example are:

1. A Coca-Cola campaign with a total of four assets and 3 campaign items directing placement opportunities of those assets as follows:
a) Asset 1 for 100 views anytime;
b) Asset 2 for any viewing opportunities Monday through Friday between the hours of 5pm and 10pm; and
c) Assets 3 and 4 for any viewing opportunities Friday and Saturday between the hours of 5pm and 10pm.

2. A Pepsi-Cola campaign with a total of five assets and four campaign items directing placement opportunities of those assets as follows:
a) Asset 1 for 20 views anytime;
b) Asset 2 for 100 views anytime;
c) Asset 3 for 1000 views anytime;
d) Asset 4 for any viewing opportunities Monday through Friday between the hours of 5pm and 10pm; and
e) Asset 5 for any viewing opportunities Friday and Saturday between the hours of 5pm and 10pm.

3. A Capital One credit card campaign with a total of four assets and three campaign items directing placement opportunities of those assets as follows:
a) Asset 1 for 100 views anytime;
b) Asset 2 for 1000 views anytime; and
c) Assets 3 and 4 for any viewing opportunities Monday through Friday between the hours of 5pm and 10pm.

4. A Chrysler Motors campaign with a total of three assets and two campaign items directing placement opportunities of those assets as follows:
a) Asset 1 for 100 views; and
b) Assets 2 and 3 for any viewing opportunities Monday through Friday between the hours of 5pm and 10pm.

5. A Nickelodeon campaign with one asset and one campaign item directing placement opportunities of that asset as follows:
a) Asset 1 for 100 views.

Since the television show 30 Rock has a mature theme and since the Nickelodeon campaign is directed towards a younger audience, that campaign item is automatically excluded from the eligible campaign list by the AQM 451. Other remaining campaign items are excluded based on time and date (i.e., campaign items 1c and 2e).

Thus the remaining campaigns of 1a-1b, 2a -2d, 3a-c, 4a-4b are transferred to the ARM 452 for ranking Based on various factors explained in greater detail below, the ARM 452 ranks the campaigns as follows:

1. Campaign Item 2a

2. Campaign Item 1a

3. Campaign Item 3c

4. Campaign Item 2b

5. Campaign Item 4b

6. Campaign Item 4a

7. Campaign Item 1b

8. Campaign Item 1d

9. Campaign Item 2c

10. Campaign Item 1c

11. Campaign Item 2d

12. Campaign Item 3a

13. Campaign Item 3b

The ARM 452 transfers this ranked list of campaign items to the ACRM 453 to determine conflicts within the ranked list of campaign items. Typically, the six available asset placement opportunities 392-1-6 within the content 390 would be filled by the first six campaign items based on a rank determined by the ARM 452. However, since some conflicts may exist between campaigns within a particular content and/or timeslot, certain campaigns may be excluded from the placement opportunities 392 such that the ranking is reordered. For example, certain criteria may dictate that a Pepsi Cola asset may not be placed within the same content as a Coca-Cola asset. In this regard, the campaign items 1a-1d are removed from the ranked list because the Pepsi-Cola asset has the higher initial ranking, leaving the following campaign items:

1. Campaign Item 2a

2. Campaign Item 3b

3. Campaign Item 2b

4. Campaign Item 4b

5. Campaign Item 4a

6. Campaign Item 2b

7. Campaign Item 2d

8. Campaign Item 3a

9. Campaign Item 3b

With this computed, the ACRM 453 may remove the final three campaign items 7, 8, and 9 from the list as the six placement opportunities can be filled with assets. The ACRM 453 then transfers this information regarding asset placement to the COD system 303.

Once all of the campaign items at each campaign have been evaluated and no campaigns remain or once all of the placement opportunities have been filled, the ACRM 453 directs the COD system 303 to retrieve the assets based on the list generated. For example, the list may be included in a report message that is transferred to the COD system 303 to direct the COD system 303 to insert the assets into the content selected by the CPE 308. It is possible that all of the assets have been excluded during the processes described herein. Thus, the ACRM 453 may then direct the COD system 303 to not place any assets in the content selected by the CPE 457.

The ACRM 453 may even direct the COD system 303 to place assets from the local database 375 and/or the national database 376 into the selected COD content as desired. The ACRM 453 may also direct the COD system 303 to place assets relating to content, programming, or even services provided by the content provider. For example, if no assets remain, standard programming information, such as time and date, pertaining to the selected COD content may be configured as an asset and placed in the selected COD content. To further illustrate, when an episode of “Modern Family” is selected by a CPE 308 and no assets remain for insertion into the available time slots of that episode, the ACRM 453 may direct the COD system 303 to present the user of the CPE 308 with the date and time when the next episode of Modern Family can be seen.

Since it is also possible that not all of the assets in the list may be placed as there may be more assets than available opportunities, the ACRM 453 may weight the assets prior to placement in the selected COD content. For example, certain assets may provide greater value to the content provider (e.g., the television network). In this regard, the ACRM 453 may rank the remaining assets in a manner that provides the most monetary compensation to the content provider. Thus, the ACRM 453 may reduce the list of available assets for insertion to the amount of opportunities, or timeslots, in the selected COD content to provide this value to the content provider. In any case, the ACRM 453 directs the COD system 303 to place the assets in the selected COD content based on the ranked list. Once placement has been directed, the ACRM 453 generates a placement report and transfers that report to the headend 301 so that the headend 301 can track marketing views (e.g., for later negotiations between content providers and marketers). For example, when a marketer can know how many views of a particular asset there were in a selected COD content, the marketer can assign a value to that asset that may be used in negotiating price for additional views of the asset in future selected COD content.

Generally, assets promoting products and services are maintained in databases by asset owners. A campaign manager may include the databases that store local and national advertisements for COD content insertion in addition to the various campaign rules that are to be implemented with the COD content insertion. For example, the asset owners develop campaigns which are subsequently managed and maintained by the campaign manager. The asset campaigns comprise rules and asset descriptions (e.g., configured as a data structure) that an asset owner may believe serves the asset owner's best marketing interests. Then, these campaigns are passed to the ADS 100 for the ADS 100 to determine the best manner in which the assets of the asset owners are to be inserted into the COD content provided by the COD provider 104.

The rules of the asset campaigns assist the ADS in determining how to exclude and/or promote certain assets in the COD content. For example, the Coca-Cola Company may have a number of advertisements it wishes to be inserted into COD content. Each of those advertisements may be associated with a campaign that targets various demographics of viewers (e.g., age, sex, ethnicity, location, etc.). Some of those assets may even cross multiple campaigns. And, each asset campaign has rules that may, for example, prevent Pepsi-Cola Company advertisements from being inserted too close in time to Coca-Cola advertisements. The campaign manager 102 manages these asset campaigns and provides them to the ADS 100 such that the ADS 100 can select assets that provide value to the COD provider 104 while complying with the rules of the asset campaigns.

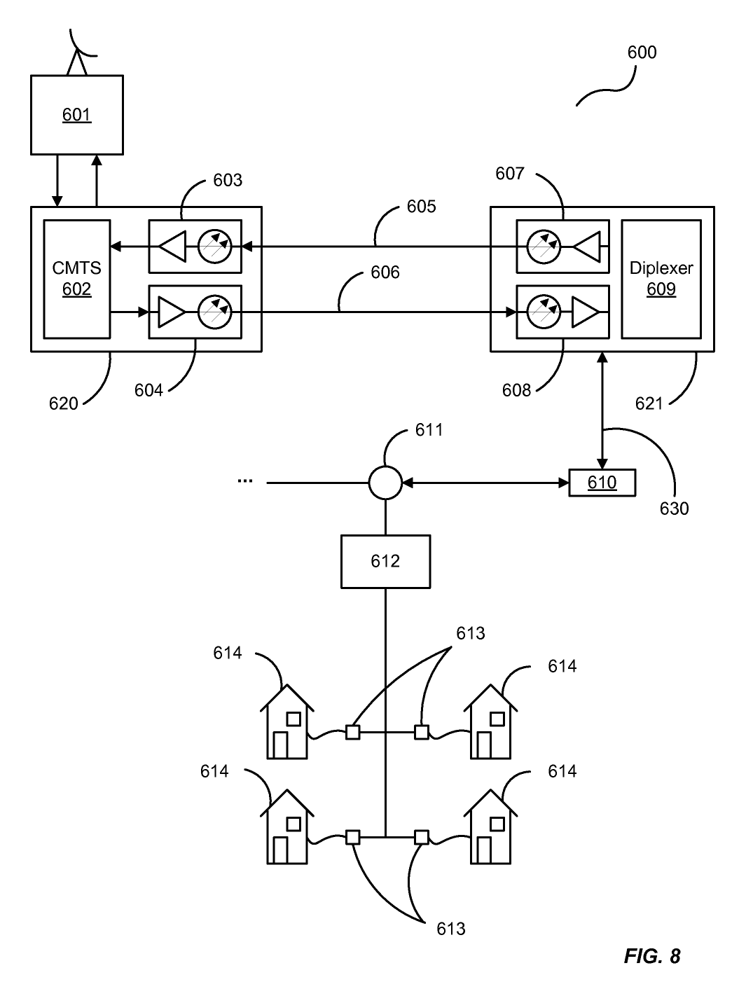

FIG. 8 is a block diagram of one exemplary cable television system 600 operable as a COD provider 104 and thus operable with the ADSs 100 and the COD insertion request manager 102. An upstream link of the cable television communication system, in this embodiment, provides high speed data services being delivered over devices conforming to the Data Over Cable Service Interface Specification (DOCSIS) specification. The communication system 600 includes a headend 601 configured with an upstream hub 620. The hub 620 is coupled to a downstream node 621 via optical communication links 605 and 606.

The hub 620 includes a Cable Modem Termination System (CMTS) 602, an electrical to optical converter 603, and an optical to electrical converter 604. The node 621 is similarly configured with an optical to electrical converter 608 and an electrical to optical converter 607. The headend 601 is generally the source for various television signals. Antennas may receive television signals that are converted as necessary and transmitted over fiber optic cables 605 to the hub 620. Several hubs may be connected to a single headend 601 and the hub 620 may be connected to several nodes 621 by fiber optic cable links 605 and 606. The CMTS 602 may be configured in the headend 601 or in the hub 620. The fiber optic links 605 and 606 are typically driven by laser diodes, such as Fabry Perot and distributed feedback laser diodes.

Downstream, in homes/businesses are devices (e.g., CPEs 308 such as cable modems or “CMs” not shown). A CM acts as a host for an Internet Protocol (IP) device such as personal computer. Transmissions from the CMTS 602 to the CM are carried over the downstream portion of the cable television communication system generally from 54 to 860 MHz. Downstream digital transmissions are continuous and are typically monitored by many CMs. Upstream transmissions from the CMs to the CMTS 602 are typically carried in the 5-42 MHz frequency band, the upstream bandwidth being shared by the CMs that are on-line. However, with greater demands for data, additional frequency bands and bandwidths are continuously being considered and tested, including those frequency bands used in the downstream paths.

The CMTS 602 connects the local CM network to an Internet backbone. The CMTS 602 connects to the downstream path through the electrical to optical converter 604 that is connected to the fiber optic cable 606, which in turn, is connected to the optical to electrical converter 608 at the node 621. The signal is transmitted to a diplexer 609 that combines the upstream and downstream signals onto a single cable. The diplexer 609 allows the different frequency bands to be combined onto the same cable. The downstream channel width in the United States is generally 6 megahertz with the downstream signals being transmitted in the 54 to 860 MHz band. Upstream signals are presently transmitted between 5 and 42 MHz, but again other larger bands are being considered to provide increased capacity. So, the variably assigned bit resolution concepts herein may be particularly advantageous. However, the invention is not intended to be limited to any particular form of communication system.

After the downstream signal leaves the node 621, the signal is typically carried by a coaxial cable 630. At various stages, a power inserter 610 may be used to power the coaxial line equipment, such as amplifiers or other equipment. The signal may be split with a splitter 611 to branch the signal. Further, at various locations, bi-directional amplifiers 612 may boost and even split the signal. Taps 613 along branches provide connections to subscriber's homes 614 and businesses.

Upstream transmissions from subscribers to the hub 620/headend 601 occur by passing through the same coaxial cable 630 as the downstream signals, in the opposite direction on a different frequency band. The upstream signals are sent typically utilizing Quadrature Amplitude Modulation (QAM) with forward error correction. The upstream signals can employ any level of QAM, including 8 QAM, 32 QAM, 64 QAM, and even 4096 QAM. Modulation techniques such as Synchronous Code Division Multiple Access (S-CDMA) and Orthogonal Frequency Division Multiple Access (OFDMA) can also be used. Of course, any type of modulation technique can be used, as desired.

Transmissions, in this embodiment, are typically sent in a frequency/time division multiplexing access (FDMA/TDMA) scheme, as specified in the DOCSIS standards. The diplexer 609 splits the lower frequency signals from the higher frequency signals so that the lower frequency, upstream signals can be applied to the electrical to optical converter 607 in the upstream path. The electrical to optical converter 607 converts the upstream electrical signals to light waves which are sent through fiber optic cable 605 and received by optical to electrical converter 603 in the node 620.

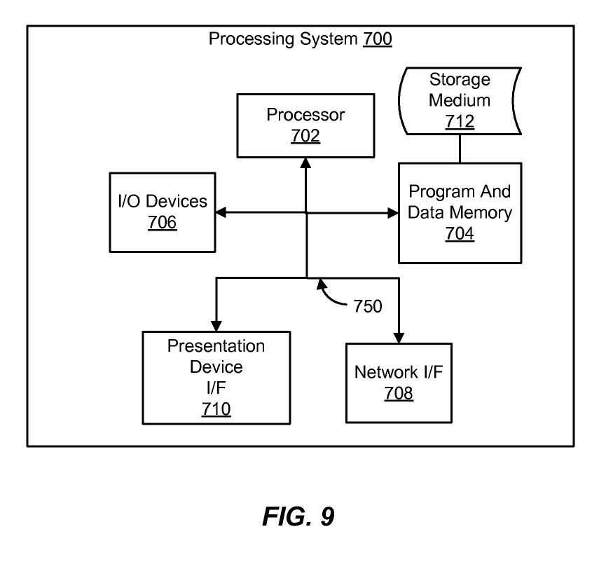

FIG. 9 illustrates an exemplary processing system 700 that is operable to implement one or more of the embodiments hereinabove. For example, some of the embodiments of the invention can take the form of a computer program accessible via the computer-readable storage medium 712. The storage medium provides program code for use by a computer or any other instruction execution system. For the purposes of this description, computer readable storage medium 712 can be anything that can contain, store, communicate, or transport the program for use by a computer.

The computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk—read/write (CD-R/W), and DVD.

The processing system 700, being suitable for storing and/or executing the program code, includes at least one processor 702 coupled to memory elements 704 through a system bus 750. Memory elements 704 can include local memory employed during actual execution of the program code, bulk storage, and cache memories that provide temporary storage of at least some program code and/or data in order to reduce the number of times the code and/or data are retrieved from bulk storage during execution.

Input/output (I/O) devices 706 (including but not limited to keyboards, displays, pointing devices, etc.) can be coupled to the processing system 700 either directly or through intervening I/O controllers. Network adapter interfaces 708 may also be coupled to the system to enable the processing system 700 to become coupled to other processing systems or storage devices through intervening private or public networks. Modems, cable modems, IBM Channel attachments, SCSI, Fibre Channel, and Ethernet cards are just a few of the currently available types of network or host interface adapters. Presentation device interface 710 may be coupled to the system to interface to one or more presentation devices, such as printing systems and displays for presentation of presentation data generated by the processor 702.

While the invention has been illustrated and described in detail in the drawings and foregoing description, such illustration and description is to be considered as exemplary and not restrictive in character. Certain embodiments described hereinabove may be combinable with other described embodiments and/or arranged in other ways. Accordingly, it should be understood that only a preferred embodiment and variants thereof have been shown and described and that all changes and modifications that come within the spirit of the invention are desired to be protected.

Additionally, although the term “headend” generally suggests the distribution center or office of a cable television operator or MSO, the term is not intended to be so limited. The term headend as used herein is any system operable to deliver content to a viewer (e.g., a customer or user of the CPE). For example, the term headend may encompass satellite content providers that offer COD content and/or Internet services to its subscribers. That content is typically delivered directly to the subscriber's antenna for demodulation and decryption by the subscriber's CPE 308. Internet traffic in such a system may be conveyed by satellite and/or other delivery mechanisms (e.g., digital subscriber lines, or “DSL”, delivered through subscriber phone lines).

A headend may also refer to a telecom provider that distributes content to mobile phones and other devices. Also, the term “asset”, as used herein, includes any type of media for which an owner desires promotion. Examples of such include traditional television commercials, advertisements, streaming video commercials, promotional materials, marketing information, and the like. The term “content”, as used herein, is any type of media, such as audio and/or video, in which assets may be inserted. For example, the content operable within the COD delivery systems described herein may be streamed Internet audio/video, analog cable television feeds, digital cable television feeds, digital satellite television feeds, or digital satellite radio feeds. Thus, the content of the COD described herein is intended to encompass Video on Demand (VOD) and pay-per-view (PPV) delivered by both modern cable television and satellite television.

1. A system operable in a Content On Demand (COD) environment, the system comprising:
a request manager operable with an asset availability database operable to process a request from an asset decision system (ADS) for assets available for insertion into a COD content selection, and to determine a geographic region of the COD content selection, and to determine availability of assets in the geographic region, to format a message with the available assets in the geographic region,
wherein the geographic region is one of a plurality of geographic regions in a COD delivery footprint of the COD content selection; and
a masking module operable to obfuscate the geographic region in the message, and to transfer the message to the ADS for a determination of assets for insertion into the COD content selection.

2. The system of claim 1, wherein:
the masking module comprises a hash table operable to encrypt information about the geographic region with a hashing algorithm.

3. The system of claim 1, wherein:
the request manager is further operable to contact a COD provider in response to the request by the ADS.

4. A method operable in a Content On Demand (COD) environment, the method comprising:
processing a request from an asset decision system (ADS) for assets available for insertion into a COD content selection;
determining a geographic region of the COD content selection;
determining availability of assets in the geographic region;
formatting a message with the available assets in the geographic region,
wherein the geographic region is one of a plurality of geographic regions in a COD delivery footprint of the COD content selection;
obfuscating the geographic region in the message; and
transferring the message to the ADS for a determination of assets for insertion into the COD content.

5. The method of claim 4, wherein obfuscating the geographic region in the message comprises:
encrypting information about the geographic region with a hashing algorithm.

6. The method of claim 4, further comprising:
contacting a COD provider in response to the request by the ADS to determine the geographic region of the COD content selection.

7. A non-transitory computer readable medium comprising instructions that, when executed by a processor in a request manager operable in a Content On Demand (COD) environment, direct the processor to:
process a request from an asset decision system (ADS) for assets available for insertion into a COD content selection;
determine a geographic region of the COD content selection;
determine availability of assets in the geographic region;
format a message with the available assets in the geographic region,
wherein the geographic region is one of a plurality of geographic regions in a COD delivery footprint of the COD content selection;
obfuscate the geographic region in the message; and
transfer the message to the ADS for a determination of assets for insertion into the COD content.

8. The computer readable medium of claim 7, wherein:
the instructions further direct the processor to obfuscate the geographic region in the message by encrypting information about the geographic region with a hashing algorithm.

9. The computer readable medium of claim 7, further comprising instructions that direct the processor to:
contact a COD provider in response to the request by the ADS to determine the geographic region of the COD content selection.
